(19) United States
(12) Patent Application Publication
(10) Pub. No.: US 2025/0198135 A1
(43) Pub. Date: Jun. 19, 2025

(54) AN ADSORPTION MOISTURE PUMP BASED AIR TO WATER HARVESTING DEVICE AND A METHOD THEREOF

(71) Applicant: BRY AIR (ASIA) PVT. LTD., Delhi, New Delhi (IN)

(72) Inventors: Varun PAHWA, Delhi, New Delhi (IN); Deepak PAHWA, Delhi, New Delhi (IN); Kuldeep MALIK, Delhi, New Delhi (IN); Manish MALIK, Delhi, New Delhi (IN); Rajan SACHDEV, Delhi, New Delhi (IN); Ahmed REZK, Birmingham (GB)

(21) Appl. No.: 18/849,396

(22) PCT Filed: Mar. 17, 2023
(86) PCT No.: PCT/IN2023/050258

§ 371 Date: Sep. 20, 2024

(30) Foreign Application Priority Data
Mar. 21, 2022 (IN) 202211015520

(51) Int. Cl. E03B 3/28; B01D 53/00; B01D 53/06; B01D 53/26; B01D 53/30

(52) U.S. Cl. CPC E03B 3/28; B01D 53/002; B01D 53/06; B01D 53/261; B01D 53/265; B01D 53/30; B01D 2253/3425; B01D 2257/80; B01D 2258/06; B01D 2259/40086

(57) ABSTRACT

The present invention relates to an adsorption moisture pump based air to water harvesting device and a method of harvesting water from ambient air. The water harvesting device [1100] comprises a rotary desiccant unit, a heat pump unit [1104] and a control unit. The rotary desiccant unit comprises a desiccant wheel [102], a reactivation air inlet [1108a], a reactivation air outlet [1108b], a process air inlet [1106a] and a process air outlet [1106b]. The desiccant wheel [1102] comprises at least a process sector [1106] and a reactivation sector [1108] and a wheel drive. The heat pump unit [1104] comprises at least one compressor, an expansion valve [1116], an evaporator [1112], a main condenser [1110], and such that a refrigerant fluid is flown sequentially within the compressor [1114], the main condenser [1110], the expansion valve [1116], and the evaporator [1112].

### FIELD OF THE INVENTION

The present invention relates to a novel an adsorption moisture pump based air to water harvesting device and a method thereof, particularly to a device and method for harvesting water from ambient air while maximizing moisture generation and minimizing the energy utilized under different climatic conditions.

### BACKGROUND TO THE INVENTION

Potable water, a threatened resource, is absolutely essential for our survival. Water scarcity has become an ever evolving challenge for the entire human race. Two major factors that are main drivers of water scarcity across the globe are increasing use of freshwater and depleting usable freshwater resource. Some of the main reasons of fresh water shortage also includes climate change, natural calamities such as droughts and floods, polluted water supplies, increased demand due to human population, urbanization, industrialization, overuse and wastage of water, global rise in freshwater demand etc. Fresh water is used for agriculture, energy production, industrial fabrication, human and ecosystem etc. At the current consumption rate and as per a key United Nations report, about 30% of the world's population will be affected by water shortage or water stress by year 2025.

In recent years, several water treatment methods and techniques have been developed in order to address these problems. The conventional methods of drinking water treatment, based on coagulation-flocculation, sedimentation, sand filtration, disinfection, ozonation, desalination etc. have not been proven very effective nowadays owing to challenges such as transportation and associated high cost.

Numerous techniques have been developed to obtain potable water in remote locations. One such technique is Air Water Harvesting, due to which the reach of potable water can be made wide and accessible to various sectors such as worksites (for example mining, construction, energy, agriculture etc.), communities (for example remote communities, water stressed communities, sustainable cities etc.), schools and universities, hospitality and other destinations (for example hotels, eco-resorts, eco venues, restaurants etc.), groups/associations working at remote locations (for example Military forces). The use of Air water generators helps in mitigating the logistical burden of water transportation/delivery.

Water as a resource is continuing to dwindle and with increase in population compounds the challenge of availability of potable water. Additionally, because of climate change there are huge variations in climatic conditions as well as increase in global temperature, referred to as global warming. All of this has accentuated the non-availability of drinking water in arid and semi-arid portions of the planet.

While there is no gainsaying that water was and continues to be a precious resource and policies and programs have been developed in relation to water use, these have largely focused on water conservation policies at both micro (individual use) level and macro (regulation of water use in industries, on recycling of waste water etc.). The alternative route of water resource management has been to develop technologies for desalination based on the presumption that brackish and/or salt water resources take up the maximum surface area of the planet. However, the desalination approach is at best implementable only by State actors, and not across society, largely due to the high infrastructure cost and operating costs which itself also leads to increased cost to the consumer. For example, the immediate problem with desalination plants is that they are very location dependent—simply put, they have to be adjacent or in close proximity to the water source. This immediately results in geometrically increasing costs of transporting treated water/desalinated water to interior regions.

Given the above problems, many small groups of researchers have started looking at alternative sources for generating water, including from the atmosphere. The atmosphere, irrespective of climatic zone or climatic period of the year, is a ready source of water since there literally is no part of the planet which has 0% moisture in the air. Pertinently, air is universal and thus the air water generator (AWG) as a method is not location-dependent. However, while several technologies have been developed (and implemented) for atmospheric water harvesting/generation (AWG), the challenges remain high, and include their high location-dependency.

The AWG technologies can broadly be categorized as using solar energy or grid-based electricity, or a combination of both, or a dual-optional input energy source. Further, the AWG technologies are predominantly heat pump-based or desiccant-based. The desiccant based technologies can be further categorized as using a fixed desiccant bed/module or rotary desiccant bed.

### DESCRIPTION OF THE PRIOR ARTS

At this stage, and in order to provide the background and context to what has been achieved through the present invention, a summary review of prior art and related art available to the Applicant is given below. The inherent problems associated with each prior art is also outlined below.

FIG. 1 (WO 2016/187709 A1) depicts a basic vapor compression refrigeration cycle with a condenser, an expansion valve, an evaporator and a compressor. The evaporator extracts heat from the ambient air and transfers it to the refrigerant, thereby cooling the ambient air. As the ambient air gets cooled in the evaporator, its relative humidity increases and condensation occurs on the coils of the evaporator. The condensed water can be collected and used as potable water. The major drawback with such kind of systems is that the relative humidity of ambient air before entering the evaporator might be low. In such a case, the ambient air entering the evaporator will need to be cooled down to a much lower temperature which will increase the load on condenser and compressor. This cannot be lower than the freezing point of water. This not only brings in a limitation but also directly impacts the efficiency of the basic vapor compression refrigeration cycle as depicted in FIG. 1. Accordingly, the basic vapor compression refrigeration cycle is not the most energy efficient approach to extracting water from the ambient air. Also, water extraction from ambient air is dependent upon high humidity and moisture in the ambient and therefore is a serious limitation for use in arid, semi-arid areas and water-stressed areas.

Another common approach has been the solar power-based approach using an adsorption rotor such as that promoted by Zero Mass Inc. of USA and (U.S. Ser. No. 10/357,739 and US20220307240, FIGS. 2 and 3 respectively). While this teaches the use of two or more adsorption rotors, the prior art essentially promotes a very complex control strategy and unit, controlling mainly the react and process airflows and the drive motor speed, wherein technology combines the use of solar power to heat the air to regenerate the rotating desiccant wheels within the air water generator (AWG). Additionally, it utilizes a solar PV panel to generate electricity to run the fans and rotate the bed drive motor. Essentially the technology is basic in principle. However, the key problems of this technology is its utter dependence on sunlight, as well as high cost of establishing the infrastructure. In simple terms, the exclusive reliance on solar power, and the attendant limitations of solar power PV technology in terms of cost, and space requirements, reduces the viability of this technology in terms of scale up. Further, the systems in FIGS. 2 and 3 do not have any heat pump and do not utilize power from the electrical grid. It is estimated that even in tropical zones or climate conditions, the water harvesting/generation yields are unlikely to exceed 5 liters per day per unit from the normal 1-2 liters/day.

FIG. 4 demonstrates yet another desiccant wheel based approach to extract water from ambient air. The desiccant wheel based approach depicted in FIG. 4 employs a chiller for supplying chilled fluid to the evaporator. Further, the system in FIG. 4 also utilizes hot fluid from an external source for heating the air entering the thermal unit. It is obvious that such a system will require more energy and several different sources of energy and apparatuses dependent upon production of chilled fluid and hot fluid with inherent energy conversion losses, to at least produce the chilled fluid and hot fluid. Accordingly, the overall efficiency of the system in FIG. 4 measured in terms of liters of water extracted per watt of power would be much lower, thereby making it energy inefficient.

Yet another technology which has been recently developed indigenously in India (WO2022074682) uses conventional desiccant material such as silica gel in static bed form to adsorb moisture from air, and then regenerates/harvests water from the desiccant material after complete saturation, using solar power. Again, while the technology is promising, there are attendant problems such as the non-continuous operation since the system cannot work on a 24/7 cycle. To overcome this, a buffer heat storage is suggested. This is not always practical in size, capacity, cost etc. Typically, the functioning of this system is limited to only periods of time when sunlight is plentiful and constant. This implicitly increases the cost if high water yield is an objective. To the extent that the Applicant herein have been able to determine, the use of grid power in this technology is limited to operation of fans as a means to move air.

Grid based electricity AWG systems typically fall in the following categories:
Using refrigeration;
Using air compression;
Using liquid desiccant and absorption technology; and
Using heat pump and adsorption modules.

WaHa Inc. of USA claims to have developed a technology for AWG using a combination of adsorption module(s) and a heat pump. The developed technology appears to be very material dependent as well as very location dependent. To the extent that the Applicant herein has been able to determine, while the method does appear to provide flexibility in capacity/yield, the system of the WaHa technology is dependent on a proprietary metal organic framework (MOF), and is further focused on areas with low atmospheric humidity e.g. Sahara and Sub—Sahara. In addition, one immediate disadvantage of this system is that while operation may be continuous due to its exclusive reliance on grid power, the infrastructure costs are as high as the operating costs, apart from the absence of flexibility in terms of location where the system is to be installed. The focus is entirely on dry/arid areas—and thus effectively rules out implementation in areas where while ground water resources may be high, the problem is one of contamination and not absence of water. Also, the cost in cents per liter of water is quite high, particularly when averaged over the year for dry climates. Furthermore, being modular and cyclic, in each cycle, the water generation will vary from high to low before end of cycle and therefore does not provide a continuous uniform water extraction rate as would be possible in the present invention.

One interesting technology which appears to be commercialized is based on liquid desiccants (using a proprietary material called Absium), using absorption. Drupps SE, the owner of this technology, claims that the technology enables recovery of around 80% of water from the atmosphere. However, the entire focus of this technology is on absorption, and on high wastewater/vapor/steam by-product generating industries, and the focus seems to be on enabling recycling of such wastewater/vapor/steam with the AWG component being more of a fringe advantage. Secondly, given the very nature of this technology, viz., focus on absorption to enable recycling as the primary objective rather than AWG, and the fact that liquid desiccants are notoriously corrosive and highly demanding in terms of the number of mechanical components and the required maintenance, the technology may not be very useful for pure AWG purposes.

The above adsorption based technologies were developed largely in response to the problems perceived from conventional/known refrigeration based water harvesting/generation systems—viz., the problem of equipment space due to the size, as well as costs of setting up, which offset the yield factor. An additional problem is that these areas of technology consume very high energy, thereby leading to high costs of operation.

An analysis of the publicly/commercially available technologies shows up the following issues/challenges.

Such technologies are inflexible since they are usually very location-dependent, either based on the final application (such as industrial wastewater recycling, or usage in arid zones with low humidity), or are very adsorbent dependent e.g. a class MOFs such as 303, or require high capital expenditure on setting up the infrastructure if high yields are required, including due to the equipment size, or material costs, on high infrastructure arid zone usage, or high operating costs due to being very energy intensive, or suffer from the risk of non-continuous operation due to extensive if not total reliance on solar PV power.

Thus, as is evident, the significant challenges faced in hitherto commercially/publicly available technologies is their limited use due to absence of flexibility for operation, high and very energy intensive operation which pushes up the capital cost and operating cost that negates the benefits of increasing the yield of water, limited or specific environment application—either arid zones or industrial zones, excessive reliance on corrosive material such as liquid desiccants, etc.

The Applicant herein, based on their experience as world leaders in rotary desiccant based technology and its wide application across environments and locations in heating, ventilation and air conditioning (HVAC) systems, evaluated the issues arising from or existing in commercially available technologies. It was concluded that the rotary desiccant based system could be utilized for AWG if certain changes in the structure could be carried out, and in a manner where the conventional role in HVAC is not sacrificed. Thus, the challenge was to develop a rotary desiccant system which could not only carry out the conventional performance (used for HVAC) but also be implementable for AWG and is geography/location/time independent.

Further, U.S. Ser. No. 11/065,573 (FIG. 5) discloses a rotary desiccant system for extracting water from ambient air, comprising an air duct for the process air, an air duct for the regeneration air and a sorption exchanger moving at least partially between the two air ducts. Additionally, in the air duct for the regeneration air, on the side facing the sorption exchanger outlet, a cooler is installed, and on the side facing its inlet, a heater is installed. The apparatus also comprises a closed refrigerant circuit. The cooler for cooling the regeneration air is a refrigerant evaporator and this cooler is, by the refrigerant piping via a compressor for the evaporated refrigerant suction and compression, connected to the regeneration air heater, where this heaterfor heating the regeneration air is a condenser for condensing the refrigerant vapor. The apparatus also comprises a subcooler for additional heat removal from the refrigerant. While the subcooler is specifically limited to the process air stream, after the wheel, no advantage is touted for doing so, whereas there is a specific disadvantage, as the subcooler operates inefficiently in this placement, particularly in higher ambient temperatures.

The system of U.S. Ser. No. 11/065,573 (FIG. 5) provides for the extraction of air by using extracting water from ambient air comprising two air ducts including an air duct for process air and an air duct for regeneration air, wherein the air duct for the process air has a process air inlet at one end of the air duct for the process air and a process air outlet at another end of the air duct for the process air, wherein the air duct for the regeneration air has a regeneration air inlet at one end of the air duct for the regeneration air and a regeneration air outlet at another end of the air duct for the regeneration air, and wherein the process air inlet, the process air outlet, the regeneration air inlet and the regeneration air outlet are connected to ambient environment; a sorption exchanger positioned at least partially in at least one of the two air ducts and is movable in such a manner that at least a portion of a volume of the sorption exchanger is transferable between the two air ducts, wherein, in both of the two air ducts, a space for the sorption exchanger is allocated for placing the sorption exchanger; a first suction device located in the air duct for the process air; a second suction device located in the air duct for the regeneration air in the air duct for the regeneration air, a heater for heating the regeneration air and a cooler configured to have a surface temperature below a dew point for cooling the regeneration air, the heater and the cooler being positioned in such a manner that the space for the sorption exchanger is located between the heater and the cooler, and the second suction device is located anywhere in the air duct for the regeneration air in such a manner that the second suction device is configured to draw air in a first direction from the heater to the cooler; an element for collection of water condensed from the regeneration air; a closed refrigerant circuit including a refrigerant and refrigerant piping, wherein the cooler for cooling the regeneration air is a refrigerant evaporator, and the cooler is interconnected by the refrigerant piping via a compressor for suction and compression of the evaporated refrigerant, with the heater for heating the regeneration air, wherein the heater for heating the regeneration air is a condenser for condensing refrigerant vapor; and a sub-cooler for additional heat removal from the refrigerant, the sub-cooler being connected to the heater via the refrigerant piping and also being connected through an expansion valve to the cooler via the refrigerant piping.

The issue arising from the system and process described in U.S. Ser. No. 11/065,573 (FIG. 5) is that it uses process air to sub-cool a second stage heat pump condenser which has the challenge of efficiency due to its higher sensible heat over ambient air or air after the desiccant drum/wheel, since the adsorption process is exothermic. This eventually negatively impacts the performance of the heat pump, hence the cost of produced clean water. Thus the challenge in this system is to provide efficiency in heat pump operation without compromising on water yield capacity.

In U.S. Pat. No. 11,065,573, the 2nd condenser is installed at the process air outlet. The present invention should outperform this prior art's design as process out air is at higher temperature as compared to air after evaporator. But, air flow at the process side is much higher than the reactivation air side, so more heat can be rejected by installing bigger condenser at the process outside. Theoretically, heat pump (HP) coefficient of performance (COP) will be better for lower condenser temperature.

Therefore, there is a need for a water harvesting apparatus which, inter alia, can be used in a wide variety of locations ranging from tropical (high humidity) to semi-arid/arid (low humidity) region. There is also the need of a water harvesting apparatus capable of operating throughout the day in an energy efficient way (in terms of liters of water extracted per watt of power spent).

### OBJECTS OF THE INVENTION

In the present invention specially configured desiccant wheel is used as an adsorption based moisture generator thereby, increasing the available water vapor for harvesting.

The invention utilizes a combination of rotary desiccant system, a heat pump comprising a capacity controlled compressor, a control unit, and a dual energy [solar PV or grid or combination] input for 24/7 moisture generation in an energy efficient manner.

The main purpose of the adsorption based moisture generator and method provided herein is to enable achievement of significantly important objective of operating in a wide variety of locations, ranging from high humidity to low humidity regions. Additionally, an important objective is energy efficient water extraction (liters/kW) from ambient air. The invention also envisages maximum water extraction (liters/day) while utilizing energy sources which allow operation 24/7 throughout the year.

### SUMMARY OF THE INVENTION

The present disclosure relates to an adsorption moisture pump based air to water harvesting device. The adsorption moisture pump based air to water harvesting device comprises a rotary desiccant unit, a heat pump unit and a control unit. The rotary desiccant unit includes a desiccant wheel, a reactivation air inlet, a reactivation air outlet, a process air inlet and a process air outlet. The desiccant wheel includes at least a process sector and a reactivation sector and a wheel drive. The reactivation air inlet and the reactivation outlet are connected such that reactivation air is supplied from the reactivation air inlet to the reactivation air outlet through the reactivation sector. The process air inlet and the process air outlet are connected such that process air is supplied from the process air inlet to the process air outlet through the process sector. The heat pump unit comprises at least one compressor, an expansion valve; an evaporator, a main condenser, and such that a refrigerant fluid is flown sequentially within the compressor, the main condenser, the expansion valve, and the evaporator. The main condenser receives the reactivation air from the reactivation air inlet, before supplying the same to the reactivation sector. The evaporator receives the reactivation air from the reactivation air outlet after the same exits the reactivation sector, causing condensation of water from the reactivation air passing therethrough. The compressor of the heat pump unit is a capacity controlled compressor. Further, the reactivation air in the reactivation air outlet is mixed with process air in the process air inlet, whenever higher in moisture content than the outside ambient moisture content. Furthermore, the control unit is adapted to receive one or more input parameters from the group consisting of an ambient temperature, an ambient humidity, a reactivation air inlet temperature, an operating mode and control one or more of compressor capacity, react-to-process air, react run-around, auxiliary condenser, evaporator temperature, based on the received input parameters.

Another aspect of the present disclosure is related to the heat pump unit further comprising an auxiliary condenser, such that refrigerant fluid is flown sequentially to the main condenser, then the auxiliary condenser, expansion valve, the evaporator, and back to the compressor. The auxiliary condenser is adapted to receive the reactivation air from the evaporator or an ambient air. process air outlet process air inlet.

Yet another aspect of the present disclosure is related to the adsorption moisture pump based air to water harvesting device wherein a portion of reactivation air from the reactivation air outlet is recirculated to the reactivation air inlet.

Yet another aspect of the present disclosure is related to the compressor being a capacity controlled compressor wherein the compressor capacity is varied by varying either speed or electronic control or hot gas bypass, based on the input parameters received by the control unit, in order to achieve a desired water extraction in terms of liters/day capacity or energy minimization in terms of liters/kW.

Yet another aspect of the present disclosure is related to the adsorption moisture pump based air to water harvesting device being powered from a grid, one or more solar photovoltaic cells, or a combination thereof.

Yet another aspect of the present disclosure is related to supplying a portion of the cooled reactivation out air to a closed space as conditioned air.

The present disclosure is also related to a method of harvesting water from ambient air. The method comprises installing a rotary desiccant unit having a desiccant wheel comprising at least a process sector and a reactivation sector, such that the rotary desiccant unit defines, a reactivation air inlet and a reactivation air outlet allowing the reactivation air to pass therethrough, and a process air inlet and a process air outlet allowing the process air to pass therethrough; installing a heat pump unit functioning in relation with the rotary desiccant unit, such that the heat pump unit comprises: at least one compressor, an expansion valve; an evaporator, a main condenser, and a refrigerant fluid is flown sequentially within the compressor, the main condenser, the expansion valve, and the evaporator; installing a control unit. The main condenser receives the reactivation air from the reactivation air inlet, before supplying the same to the reactivation sector; the evaporator receives the reactivation air from the reactivation air outlet after the same exits the reactivation sector, causing condensation of water from the reactivation air passing therethrough; the compressor is a capacity controlled compressor; reactivation air in the reactivation air outlet is mixed with process air in the process air inlet in the circumstance when the react outlet moisture content is higher than the ambient moisture content and the control unit is adapted to receive one or more input parameters from the group consisting of an ambient temperature, an ambient humidity, a reactivation air inlet temperature, an operating mode; and control one or more of compressor capacity, react-to-process air, react-run-around, auxiliary condenser, evaporator temperature, based on the received input parameters.

Yet another aspect of the present disclosure is related to the method of harvesting water from ambient air comprising receiving the reactivation air from the evaporator or an ambient air in an auxiliary condenser of the heat pump unit to transfer heat from the refrigerant fluid to the inflowing reactivation air. The auxiliary condenser is placed such that refrigerant fluid is flown sequentially to the main condenser, then the auxiliary condenser, expansion valve, the evaporator and back to the compressor.

Yet another aspect of the present disclosure is related to the method of harvesting water from ambient air wherein a portion of reactivation air from the reactivation air outlet is recirculated to the reactivation air inlet.

Yet another aspect of the present disclosure is related to the method of harvesting water from ambient air wherein the compressor is a capacity controlled compressor wherein the compressor capacity is varied by varying either speed or electronic control or hot gas bypass, based on the input parameters received by the control unit, in order to achieve a desired water extraction capacity (liters/day) or energy minimization (liters/kW).

Yet another aspect of the present disclosure is related to the method of harvesting water from ambient air comprising powering the water harvesting device from a grid, one or more solar photovoltaic cells, or a combination thereof.

Yet another aspect of the present disclosure is related to the method of harvesting water from ambient air wherein the method comprises supplying a portion of the cooled reactivation out air to a closed space as conditioned air.

### BRIEF DESCRIPTION OF DRAWINGS

FIG. 1 shows a basic vapor compression refrigeration cycle well known in the prior art.

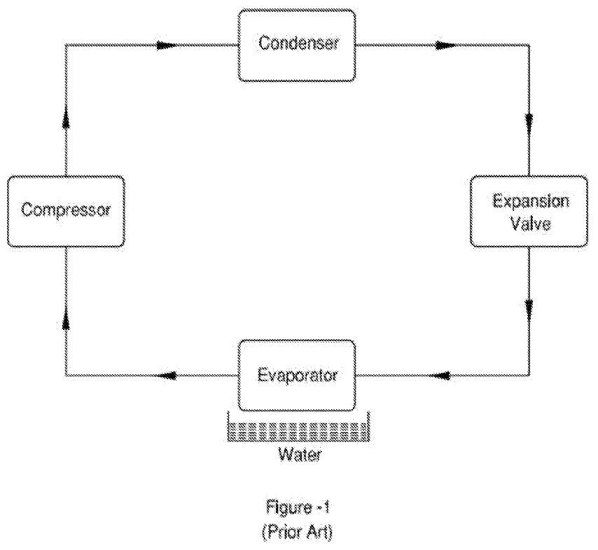

FIG. 2a shows a prior art system for extracting water from atmospheric air utilizing two desiccant units, a solar thermal unit and an air to air condenser.

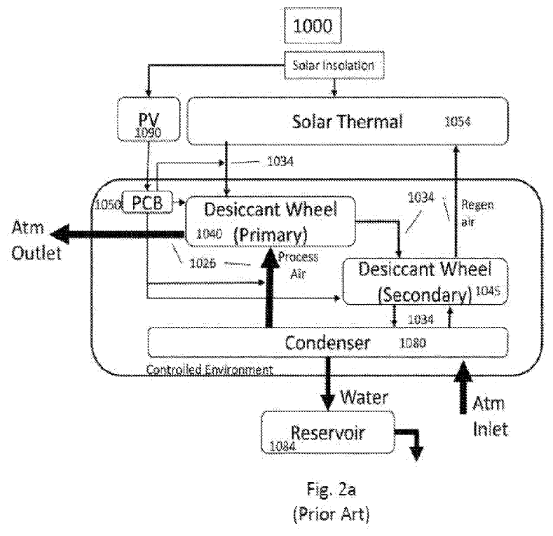

FIG. 2b is a prior art showing the control logic for the system shown in FIG. 2a.

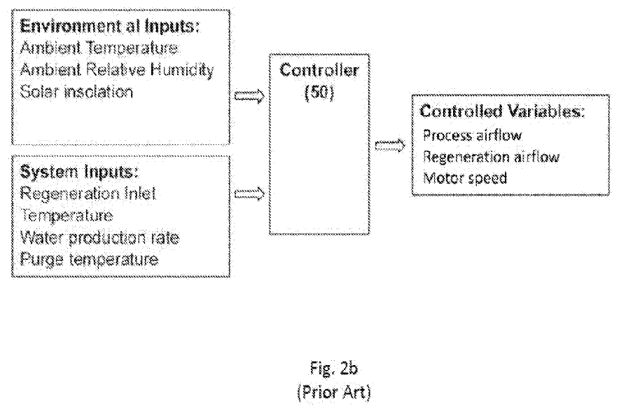

FIG. 3 shows a prior art system for extracting water from atmospheric air utilizing three desiccant units, a thermal unit and an air to air condenser.

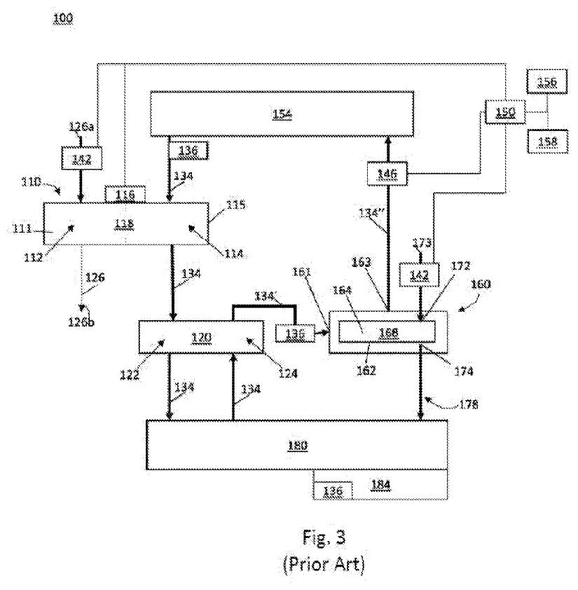

FIG. 4 shows a prior art system for extracting water from atmospheric air utilizing a desiccant unit, a chilled fluid supply and a hot fluid supply.

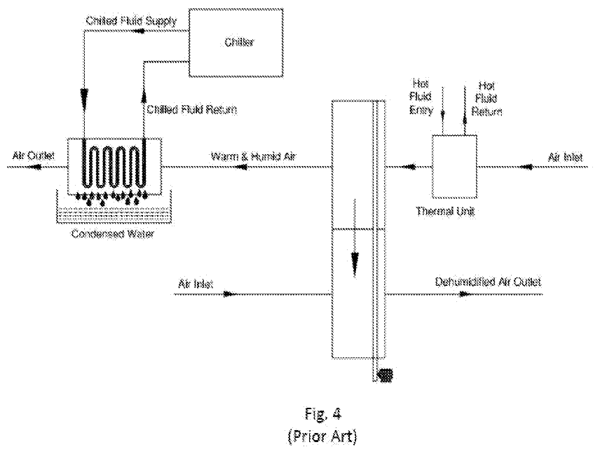

FIG. 5 shows a prior art system for extracting water from atmospheric air utilizing a desiccant unit, a compressor, two liquid to air heat exchangers, a sub cooler and an expansion valve.

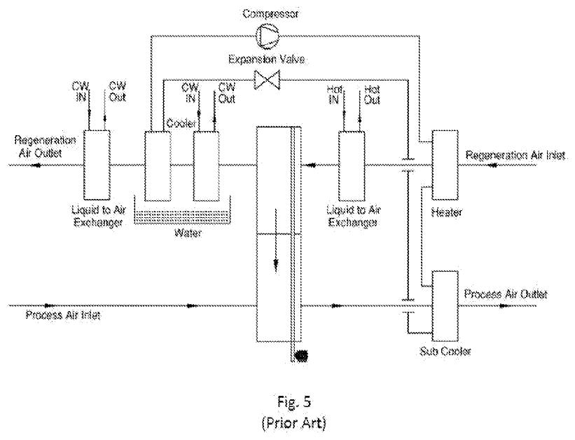

FIG. 6 shows a schematic of an adsorption based moisture generator as an embodiment of the invention.

FIG. 7a shows a schematic of an adsorption based moisture generator as per another embodiment of the invention.

FIG. 7b shows a schematic of an adsorption based moisture generator as per yet another embodiment of the invention.

FIG. 8 shows a schematic of an adsorption based moisture generator as per yet another embodiment of the invention.

### DETAILED DESCRIPTION OF INVENTION

In the following description, for the purposes of explanation, various specific details are set forth in order to provide a thorough understanding of embodiments of the present invention. It will be apparent, however, that embodiments of the present invention may be practiced without these specific details. Several features described hereinafter can each be used independently of one another or with any combination of other features. An individual feature may not address any of the problems discussed above or might address only one of the problems discussed above. Some of the problems discussed above might not be fully addressed by any of the features described herein. Example embodiments of the present invention are described below, as illustrated in various drawings in which reference numerals refer to the same parts through the different drawings.

### This Invention

The underlying premise of the present invention is to extract water from ambient air in a wide variety of regions (from high humidity tropical region to low humidity arid/semi-arid region) in an energy efficient manner 24/7 throughout the year. The unique design and implementation of the invention ensures that the same is advantageous in a variety of climatic conditions such as tropical, sub-tropical, arid, semi-arid etc. The climate independent implementation makes the present system flexible such that the present system is usable in a variety of applications and industries.

The adsorption moisture pump based air to water harvesting device [1100] is adapted to extract water from ambient air while being powered from a grid, one or more solar photovoltaic cells, or a combination thereof. Utilizing a grid, one or more solar photovoltaic cells, or a combination thereof enables the adsorption moisture pump based air to water harvesting device [1100] to operate 24/7 throughout the year in an energy efficient manner in terms of liters of water extracted per watt of power spent on generating the same. The adsorption moisture pump based air to water harvesting device [1100] comprises a rotary desiccant unit, a heat pump unit [1104], a storage unit for condensed water, a control unit and one or more fans.

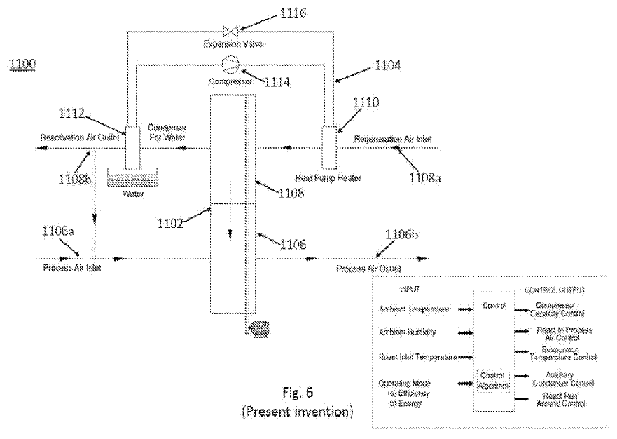

Details of a preferred embodiment of the adsorption moisture pump based air to water harvesting device [1100], in accordance with the concepts of the present disclosure, will be explained in detail hereinafter. FIG. 6 shows a schematic representation configured in such a way to extract humidity from an ambient air using an adsorption moisture pump based air to water harvesting device [1100] as per the present embodiment of the invention.

As stated above, the adsorption moisture pump based air to water harvesting device [1100] comprises the rotary desiccant unit, the heat pump unit [1104] and the control unit. The rotary desiccant unit includes a desiccant wheel [1102], a reactivation air inlet [1108a], a reactivation air outlet [1108b], a process air inlet [1106a] and a process air outlet [1106b]. The desiccant wheel [1102] includes at least a process sector [1106] and a reactivation sector [1108] and a wheel drive. The adsorption of moisture from the ambient air is performed at the process sector [1106] whereas desorption of water, previously adsorbed in the process sector [1106], is performed at the reactivation sector [1108]. The wheel drive is essentially a conventional driving mechanism adapted to rotate the desiccant wheel [1102] at a pre-determined speed. The reactivation air inlet [1108a] and the reactivation air outlet [1108b] are connected such that reactivation air is supplied from the reactivation air inlet [1108a] to the reactivation air outlet [1108b] through the reactivation sector [1108]. The process air inlet [1106a] and the process air outlet [1106b] are connected such that process air is supplied from the process air inlet [1106a] to the process air outlet [1106b] through the process sector [1106]. The process air inlet [1106a], the process air outlet [1106b], the reactivation air inlet [1108a] and the reactivation air outlet [1108b] are ducts of suitable size adapted to enable airflow therethrough. The reactivation air entering the reactivation air inlet [1108a] and the process air entering the process air inlet [1106a] is ambient air. The reactivation air flowing in the reactivation air inlet [1108a] is called as “react in air” and may be denoted by the same label as reactivation air inlet i.e. [1108a]. The reactivation air flowing the reactivation air outlet [1108b] is called as “react out air” and may be denoted by the same label as reactivation air outlet i.e. [1108b]. The process air flowing in the process air inlet [1106a] is called “process in air” and may be denoted by the same label as process air inlet i.e. [1106a]. The process air flowing in the process air outlet [1106b] is called “process out air” and may be denoted by the same label as process air outlet i.e. [1106b].

The heat pump unit [1104] comprises at least one compressor [1114], an expansion valve [1116]; an evaporator cum condenser [1112] (interchangeably referred to as “evaporator [1112]”), a main heat condenser [1110] (interchangeably referred to as “main condenser [1110]”), such that a refrigerant fluid is flown sequentially within the compressor [1114], the main condenser [1110], the expansion valve [1116], and the evaporator [1112]. The main condenser [1110] receives the reactivation air from the reactivation air inlet [1108a], before supplying the same to the reactivation sector [1108]. After the expansion valve, the evaporator [1112] receives the reactivation air from the reactivation air outlet [1108b] after the same exits the reactivation sector [108], causing condensation of water from the reactivation air passing therethrough.

Moreover, the compressor is a capacity controlled compressor. It is noteworthy that the reactivation air in the reactivation air outlet [1108b] is mixed with process air in the process air inlet [1106a], whenever higher in moisture content than the outside ambient moisture.

The main condenser [1110] of the heat pump unit [1104] facilitates heat transfer from the inflowing refrigerant fluid to the reactivation air flowing therethrough. As is customarily known, the main condenser [1110] employs a number of coils through which heated refrigerant is passed. The evaporator [1112] of the heat pump unit [1104] facilitates heat transfer from the reactivation out air flowing therethrough to the inflowing refrigerant fluid, to cause condensation of water from the high relative humidity (RH) reactivation out air. As is customarily known, the evaporator [1112] employs a number of coils through which cold refrigerant is passed. The storage unit is positioned and adapted to receive the condensed water from the evaporator [1112] unit. The compressor [1114] is a capacity controlled compressor wherein the compressor capacity is varied by varying either through speed or electronic control or hot gas bypass, based on the input parameters received by the control unit, in order to achieve a desired water extraction capacity.

The capacity controlled compressor has the advantage of consuming power proportional to the work done by the compressor. This considerably improves the energy use/efficiency in terms of liters of water generated per KW of energy input. The capacity control is through the control unit, triggered by (a) the varying load of the evaporator through selected set point of mode for maximizing water generation or minimizing energy consumption, and also by (b) the ambient air inlet to the main condenser [1110] so as to regulated air off temperature of the main condenser [1110].

The control unit of the adsorption moisture pump based air to water harvesting device [1100] is adapted to receive one or more input parameters from the group consisting of an ambient temperature, an ambient humidity, a reactivation air inlet temperature, an operating mode; and control one or more of compressor capacity, react-to-process air, react run-around, auxiliary condenser, evaporator temperature, based on the received input parameters. Controlling react-to-process air means mixing the reactivation air in the reactivation air outlet [1108b] with process air in the process air inlet [1106a], whenever higher in moisture content than the outside ambient moisture. Controlling auxiliary condenser means activating an auxiliary condenser [1118a, 1118b] (explained in detail below) when the evaporator [1112] demand cannot be fully met by the main condenser. Controlling react run-around means redirecting at least a portion of reactivation out air to reactivation in air in order to enhance the moisture content of the reactivation in air when the reactivation out air is higher in moisture content than the ambient reactivation in air. Here, the operating mode is configured to provide another means to either improve water extraction in terms of liters/day or reduce energy consumption in terms of liters/kW. The control unit includes a processing unit, wherein processor refers to any logic circuitry for processing instructions. A processor may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. The invention envisages a specialized control algorithm employed by the control unit that functions at the background to modify the working of the overall system based on input parameters, to achieve desired output in terms of water extraction capacity (liters/day) or minimal energy consumption (liters/kW) through the control of one or more of compressor capacity, react-to-process air, react run-around, auxiliary condenser, evaporator temperature. As explained separately elsewhere, some of the controlled parameters, amongst others, through the control unit, will be essentially from amongst the following:
a. Compressor capacity control: One or more compressor [1114] 's capacity control,
b. Diverting the react out air to process in air under certain conditions
c. Increase of main heat condenser [1110] air off temperature under certain operating conditions,
d. Decreasing of the evaporator [1112] air off temperature under certain operating conditions,
e. Addition of auxiliary condenser [1118a, 1118b] beyond a certain evaporator load (explained in paragraphs to follow),
f. Control of reactivation out air in lieu of diverting per #b.

The one or more fans (not shown in the figures) of the adsorption moisture pump based air to water harvesting device [1100] are adapted for generating flow of one or more of the reactivation air, and/or the process air. The invention envisages that one fan can be installed on either of two i.e. the process air inlet [1106a] and the process air outlet [1106b], for generating the flow of the process air therein. The invention is also envisaging that the same fan or another fan can be used on either of other two i.e. the reactivation air inlet [1108a] and the reactivation air outlet [1108b], for generating flow of the reactivation air therein.

As shown in FIG. 6, a reactivation air via reactivation air inlet [1108a] passes through the main condenser [1110] and gets heated while cooling the refrigerant flowing through the condenser. The heated reactivation air is then passed through reactivation sector [1108] of the desiccant wheel [1102] to desorb moisture from the reactivation sector [1108] and regenerating the desiccant wheel [1102] for further adsorbing moisture in the process sector [1106]. The reactivation air exiting from the reactivation sector [1108] is moisture laden and when passed through evaporator [1112] gets cooled down while heating the refrigerant flowing through the evaporator [1112]. The cooling down of the reactivation air in the evaporator [1112] increases the relative humidity and eventually results in condensation of moisture. The moisture removed via condensation in the evaporator [1112] is collected in the storage unit. The collected water is potable and suitable for drinking purposes. A portion of reactivation air exiting the evaporator [1112] is mixed with process air (ambient air) in process air inlet [1106a], to increase specific humidity of the process air entering the process sector [1106]. The mixture of recirculated reactivation air and process air (ambient air) is passed through the process sector [1106] of the desiccant wheel [1102] via process air inlet [1106a] wherein the mixture of recirculated reactivation air and process air rejects moisture to the desiccant regenerated in the reactivation sector [1108]. This increases the water extraction capacity (liters/day)/efficiency (liters/kW) of adsorption moisture pump based air to water harvesting device [1100], especially when dew point temperature of reactivation air exiting the evaporator [1112] is higher than the dew point temperature of process air before mixing.

A portion of the cooled reactivation out air is supplied to a closed space as conditioned air.

The desiccant wheel [1102] of the rotary desiccant unit comprises a desiccant matrix comprising one or more desiccants is adhered to a substrate. Here, the one or more desiccants are selected from the group consisting of metal organic frameworks (MOFs), covalent organic frameworks (COFs), zeolitic imidazolate frameworks (ZIFs), alone or in combination thereof, with or without an inorganic adsorbent. The one or more desiccants may also be selected from the group consisting of silica gel, zeolites, aluminas, reactive oxygen species (ROS), functionalized desiccant, alone or in combination thereof. The desiccant needs to have an affinity for water so that an ambient air passing therethrough can be dehumidified. The desiccant matrix comprises one or more smaller passages disposed axially, such that the smaller passages are formed by alternating layers of flat and corrugated substrate material carrying the one or more desiccants. The one or more smaller passages allow discrete airstreams to pass through the desiccant wheel [1102] without significant cross-mixing. It is noteworthy that the desiccant matrix is in the form of a honeycomb.

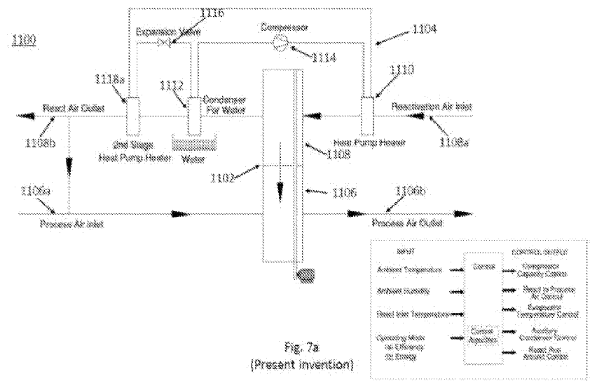

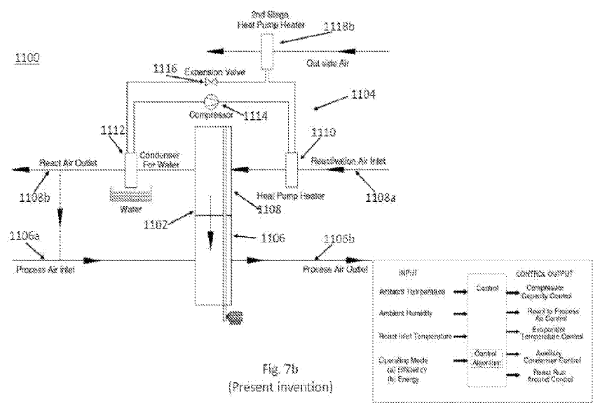

Details of another embodiment of the adsorption moisture pump based air to water harvesting device [1100], in accordance with the concepts of the present disclosure, will be explained hereinafter. FIG. 7a shows a schematic representation configured in such a way to extract humidity from an ambient air using an adsorption moisture pump based air to water harvesting device [1100] as per the present embodiment of the invention. The details pertaining to the structure and operation of the adsorption moisture pump based air to water harvesting device [1100] are already explained above. In the present embodiment, as shown in FIG. 7a, the heat pump unit [1104] further comprises an auxiliary condenser [1118a], such that refrigerant fluid is flown sequentially to the main condenser [1110], then the auxiliary condenser [1118a] the expansion valve [1116], the evaporator [1112], and back to the compressor [1114]. In the present embodiment, the auxiliary condenser [1118a] is adapted to receive the cooled reactivation air exiting the evaporator [1112]. Accordingly, the auxiliary condenser [1118a] of the heat pump unit [1104] facilitates heat transfer from the inflowing refrigerant fluid to the reactivation air flowing therethrough. Furthermore, the reactivation air from the auxiliary condenser [1118a] in the reactivation air outlet [1108b] is mixed with the process air in the process air inlet [1106a] before the process air is passed through the process sector [1106] of the desiccant wheel [1102], whenever higher in moisture content than the outside ambient moisture content.

The auxiliary condenser [1118a] is activated through the control unit when the evaporator [1112] demand cannot be fully met by the main condenser [1110].

In the above embodiment of the adsorption moisture pump based air to water harvesting device [1100], the temperature of the evaporator-treated reactivation air is lower than reactivation air flowing in reactivation air inlet [1108a] or process air flowing in process air inlet [1106a] or process air outlet [1106b], a condensing capacity of the auxiliary condenser [1118a] is highly improved. Thus, overall condensing capacity of the combination of the main condenser [1110] and the auxiliary condenser [1118a], is significantly improved. Such increase in overall condensing capacity of the combination of the main condenser [1110] and the auxiliary condenser [1118a] increases evaporative capacity of the evaporator [1112]. Accordingly, the evaporator [1112] is capable of increasing the water extraction capacity of the adsorption moisture pump based air to water harvesting device [1100]. It can be understood that in the present embodiment of the adsorption moisture pump based air to water harvesting device [1100], a ratio of water extraction capacity to electric energy consumption is substantially improved i.e. more volume of water is extracted for same amount of energy consumed.

Details of yet another embodiment of the adsorption moisture pump based air to water harvesting device [1100], in accordance with the concepts of the present disclosure, will be explained in detail hereinafter. FIG. 7b shows a schematic representation configured in such a way to extract humidity from an ambient air using an adsorption moisture pump based air to water harvesting device [1100] as per the present embodiment of the invention. The details pertaining to the structure and operation of the adsorption moisture pump based air to water harvesting device [1100] are already explained above. In the present embodiment as shown in FIG. 7b, the heat pump unit [1104] further comprises an auxiliary condenser [1118b], such that refrigerant fluid is flown sequentially to the main condenser [1110] then the auxiliary condenser [1118b] the expansion valve [1116], the evaporator [1112], and back to the compressor [1114].

In the present embodiment, the auxiliary condenser [1118b] is adapted to receive the ambient air for extracting heat from the refrigerant. Accordingly, the auxiliary condenser [1118b] of the heat pump unit [1104] facilitates heat transfer from the inflowing refrigerant fluid to the ambient air flowing therethrough.

The auxiliary condenser [1118b] is activated through the control unit when the evaporator [1112] demand cannot be fully met by the main condenser.

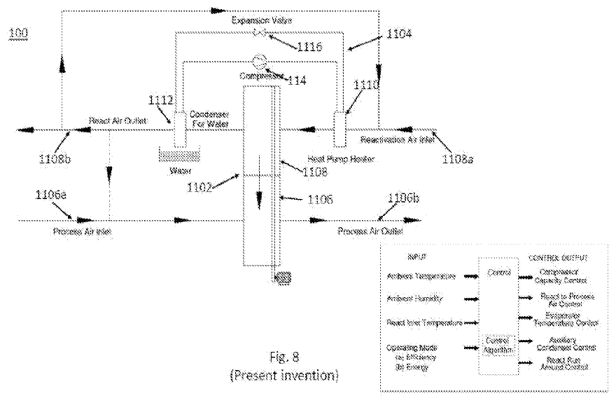

Details of yet another embodiment of the adsorption moisture pump based air to water harvesting device [1100], in accordance with the concepts of the present disclosure, will be explained in hereinafter. FIG. 8 shows a schematic representation configured in such a way to extract humidity from an ambient air using an adsorption moisture pump based air to water harvesting device [1100] as per the present embodiment of the invention. The details pertaining to the structure and operation of the present embodiment of the adsorption moisture pump based air to water harvesting device [1100] are explained in detail above. In the present embodiment, as shown in FIG. 8, the reactivation air in the reactivation air in the reactivation air outlet [1108b] is divided into two portions. One portion of the reactivation air in the reactivation air outlet [1108b] is mixed with the process air in the process air inlet [1106a], whenever higher in moisture content than the outside ambient moisture content. Another portion of the reactivation air in the reactivation air outlet [1108b] is mixed with reactivation air in the reactivation air inlet [1108a] and sequentially passed through the main condenser [110], reactivation sector [1108], evaporator [1112]. It is noteworthy that the react out air is mixed with reactivation in air only when it is lower in moisture content than the ambient reactivation in air.

With regard to each of the aforementioned embodiments of the adsorption moisture pump based air to water harvesting device [1100], it may be noted that a water extraction capacity (quantity of water extracted in a defined time period i.e. liters/day) of the adsorption moisture pump based air to water harvesting device [1100] is dependent on a temperature of evaporator [1112]. Lower the temperature of the evaporator [1112], higher is the water extraction capacity of the water harvesting device [1100]. Further, the water extraction capacity of the adsorption moisture pump based air to water harvesting device [1100] is also dependent on a temperature of the condenser. Higher the temperature of the condenser, high is the water extraction capacity of the adsorption moisture pump based air to water harvesting device [1100]. Therefore, the capacity of the compressor [1114] is controlled by a control unit to control the water extraction capacity of the air on account of electric power consumed by the compressor [1114].

A method comprises installing a rotary desiccant unit having a desiccant wheel [1102] comprising at least a process sector [1106] and a reactivation sector [1108], such that the rotary desiccant unit [1102] defines, a reactivation air inlet [1108a] and a reactivation air outlet [1108b] allowing the reactivation air to pass therethrough, and a process air inlet [1106a] and a process air outlet [1106b] allowing the process air to pass therethrough; installing a heat pump unit functioning in relation with the rotary desiccant unit, such that the heat pump unit comprises: at least one compressor [1114], an expansion valve [1116]; an evaporator [1112], a main condenser [1110], and a refrigerant fluid is flown sequentially within the compressor [1114], the main condenser [1110], the expansion valve [1116], and the evaporator [1112]; installing a control unit. The main condenser [1110] receives the reactivation air from the reactivation air inlet [1108a], before supplying the same to the reactivation sector [1108]; the evaporator [1112] receives the reactivation air from the reactivation air outlet [1108b] after the same exits the reactivation sector [1108], causing condensation of water from the reactivation air passing therethrough; the compressor [1114] is a capacity controlled compressor; the reactivation air in the reactivation air outlet [1108b] is mixed with process air in the process air inlet [1106a], whenever higher in moisture content than the outside ambient moisture content; and the control unit is adapted to receive one or more input parameters from the group consisting of an ambient temperature, an ambient humidity, a reactivation air inlet temperature, an operating mode; and control one or more of compressor capacity, react-to-process air, react run-around, auxiliary condenser, evaporator temperature, based on the received input parameters, in accordance with the embodiments of the adsorption moisture pump based air to water harvesting device [1100].

The method of harvesting water from ambient air further comprises receiving the reactivation air from the evaporator [1112] or an ambient air in an auxiliary condenser [1118a, 1118b] of the heat pump unit [1104] to transfer heat from the refrigerant fluid to the inflowing reactivation air, in accordance with the embodiments of the adsorption moisture pump based air to water harvesting device [1100]. The auxiliary condenser [1118a, 1118b] is placed such that refrigerant fluid is flown sequentially to the main condenser [1110], then the auxiliary condenser [1118a, 1118b], expansion valve [1116], the evaporator [1112], and back to the compressor [1114].

The compressor [1114] employed in the method of harvesting water from the ambient air is capacity controlled compressor wherein the compressor capacity is varied by varying either through speed or electronic control or hot gas bypass, based on the input parameters received by the control unit.

In accordance with the embodiments of the adsorption moisture pump based air to water harvesting device [1100], the method of harvesting water from the ambient air comprises recirculating a portion of reactivation air from the reactivation air outlet [1108b] to the reactivation air inlet [1108a].

In accordance with the embodiments of the adsorption moisture pump based air to water harvesting device [1100], the method of harvesting water from the ambient air comprises supplying a portion of the cooled reactivation out air to a closed space as conditioned air.

The method of harvesting water from the ambient air further comprises powering the adsorption moisture pump based air to water harvesting device [1100] from a grid, one or more solar photovoltaic cells, or a combination thereof.

Various advantages of the adsorption moisture pump based airto water harvesting device [1100] and the method of harvesting water from the ambient air, as disclosed in the embodiments above, will be discussed hereinafter.

In initial test runs, the present invention has resulted in generation of about 25 to 30 liter of water per day in a temperate climatic environment using silica gel desiccant as the desiccant material. Moreover, the present invention is ideally suited for domestic use and can be upgraded to uses where larger yields are required. In this case, while the capacity of the evaporator [1112] has to be increased, the corresponding increase in the main condenser [1110] capacity is enhanced by the use of the auxiliary condenser [1118a, 1118b], as shown in FIGS. 7a and 7b.

It is emphasized that the essential use of the heat pump unit [104] using condenser-evaporator [112] in combination with the rotary desiccant unit, as part of adsorption moisture pump based air to water harvesting device [100] and method of harvesting water from ambient air, enables easy dissipation of the heat of the system, control over the water yield levels, flexibility in operation and implementation without incurring significant infrastructure or operation costs. Therefore, the present invention is an elegant solution which addresses many challenges discussed above, without compromising the cost of installation and operation.

It is noteworthy that the present invention is desiccant agnostic. The choice of desiccant material, employed in the rotary desiccant system, used is a function of the level of adsorption required in a given climatic environment. Thus, for example, where relatively low levels of water adsorption are required due to say, high atmospheric humidity such as in tropical climatic regions, the desiccant can be silica gel. On the other hand, if the need is for maximizing yield of water such as in arid zones where the relative humidity of the ambient is low, novel materials (desiccants like, MOFs COFs ZIFs, ROS, functionalized desiccants etc.) as a material composited with salt hydrates impregnated into porous materials, depending on the location, where climatic conditions vary, can be used which have high desiccant capability. This is achieved without requiring increased infrastructure, installation or operation costs.

The added advantage of the present invention is that it is bi-functional as the apparatus and the method, as disclosed in the present disclosure, is enabled to carry out functions of room/space air conditioning as well as air water harvesting/generation.

The present invention can be power source independent as it can run on grid based power supplies or off-grid power supplies such as energy storage media or even off solar power. Essentially, the elegant simplicity of the construction enables the implementation of the system as a plug-and-play system, where the operation is not compromised due to power source disruptions. The advantage of being functional on both alternative energy sources such as solar-photovoltaic (solar-PV) or solar photovoltaic thermal (PVT) sources and grid based electricity sources is that the systems operation can be continuous i.e. 24/7 throughout the year.

The present invention is unique as it maximizes the amount of water that can be harvested while simultaneously minimizing the energy/power used to harvest the water. This is more effectively achieved in arid and semi-arid areas. Water generation is effectively measured as liter of water produced per KWh (kilowatt hour) of energy used. This is essentially achieved through a compressor [1114] whose capacity is controlled by the control unit which is based on simultaneous and separate adjustment of air temperature off from the main condenser [1110], for regenerating the wheel, and evaporator [1112] gas temperature in the evaporator [1112] of the heat pump, depending on the continuously varying ambient conditions of temperature, specific humidity, and relative humidity.

The present invention operates to decreases the ratio of the electric supply to the water extraction capacities. Particularly, this invention achieves air water harvesting at less than 0.5 kWh/liter, preferably to 0.3 kWh/liter, based on average of all year round condition, and not at a given weather conditions. Accordingly, one advantage of the present invention relates to the power source being a solar power source, a grid power source, a combination of both, and/or an alternate option for both to allow 24/7 operation throughout the year. Another advantage of the present invention relates to employing of the auxiliary condenser [1118a, 1118b], which substantially decreases the ratio of the electric supply to the water extraction capacities. Yet another advantage of the present invention relates to the variety of options of the desiccant material, which can be decided based on the ambient conditions.

Yet another advantage of the present invention relates to the control unit deployed in the present invention, which causes precise control of the water extraction capacities on expense of electric power, based on the ambient conditions. For example, in arid areas, there is a requirement of increased water extraction capacities of the adsorption moisture pump based air to water harvesting device [1100] and the method of harvesting water from the ambient air (as disclosed in present disclosure) by increasing the electric supply. In such situations, the compressor [1114] can be controlled by the control unit to increase the electric consumption for increasing the temperature of condenser and thus causing decrease in the temperature of the evaporator [1112], to output increased water extraction capacity by the adsorption moisture pump based air to water harvesting device [1100] and the method of harvesting water from ambient air, as disclosed in the present disclosure. Alternatively, in tropical regions, there is requirement of electric energy consumption while decreased requirement of water extraction capacity of adsorption moisture pump based air to water harvesting device [1100] and the method of harvesting water from ambient air (as disclosed in the present disclosure). In such situations, the compressor [1114] can be controlled by the control unit to decrease the electric consumption by decreasing the temperature of the condenser and thus increasing the temperature of the evaporator [1112], such that output water extraction capacity is decreased. Thus, such control unit of the adsorption moisture pump based air to water harvesting device [1100] is capable of adjusting the water extraction capacities of the present invention as disclosed in the present disclosure.

The following examples illustrate some of the important benefits of this adsorption based invention compared to most commonly used technology of refrigeration based air water generators.

One of the major benefits of the present invention is to be able to generate water in different climates across the globe, not limited to high humid areas as the adsorption principle operates independent of dew point, which is the major drawback/limitation of the refrigeration AWG not being able to go below 0° C. dew point. This adsorption feature of this technology is further amplified in its operation in arid and semi-arid areas. The following examples bring this out.

### Example 1

In this example, to amplify the benefit of this technology in arid and semi-arid areas, the cities of Jaipur, Abu Dhabi, Delhi and Riyadh have been selected. Using the hourly bin data for each of these cities, for the entire year of 8760 hours, the total water generated has been computed using the adsorption wheel configuration of the present invention. Similarly, the total energy consumed has also been computed for the entire year as the energy consumed, through the control unit, automatically proportionate with the water being generated at any given time, hour, day of the year. With this the total water generated/100 kW can easily be computed and is set out below, further giving liters/kW of water generated.

TABLE 1
Water generated

| | | | | Water | Litres/kW of |
|---|---|---|---|---|---|
| | | Hours/year | | generated in | water |
| | Cities | (full year) | RH | litres/100 kW | generated |
| Present | Jaipur | 8760 | 0-100% | 226.3 | 2.263 |
| Invention | Abu | 8760 | 0-100% | 256.3 | 2.563 |
| | Dhabi | | | | |
| | Riyadh | 8760 | 0-100% | 177.2 | 1.772 |
| Refrigeration | Jaipur | 8760 | 0-100% | 191.4 | 1.914 |
| based AWG | Abu | 8760 | 0-100% | 220 | 2.20 |
| (Prior art) | Dhabi | | | | |
| | Riyadh | 8760 | 0-100% | 96.03 | 0.9603 |

In the above table, the water generated is based on main heat condenser [1110] air off (reactivation air entering the reactivation sector of the desiccant wheel) temperature of about 50° C., and around 15° C. saturated air off temperature from the evaporator cum condenser [1112].

It is evident from the above that the present invention is more efficient in generating water over prior art.

### Example 2

An additional benefit of the present invention, through the control unit, is to allow the user to maximize water generation, particularly at the time of need and/or in water stressed areas. Through this mode, the control unit maximizes the water generation by lowering the saturated air off temperature of the evaporator cum condenser [1112] to around 10° C. with a higher regeneration air heat input at about 60° C. from the main heat condenser [1110].

TABLE 2
Energy Consumed to generate 100 litres of water

| | | | | Electric | Electric |
|---|---|---|---|---|---|
| | | | | Energy | energy |
| | | | | Consumed | consumed |
| | | | | in kW to | in kW to |
| | | | | generate | generate 1 |
| | | Hours/year | | 100 litres of | litre of |
| | Cities | (full year) | RH | water | water |
| Present | Jaipur | 8760 | 0-100% | 44 | 0.44 |
| Invention | Abu Dhabi | 8760 | 0-100% | 39 | 0.39 |
| | Riyadh | 8760 | 0-100% | 56 | 0.56 |
| Refrigeration | Jaipur | 8760 | 0-100% | 52 | 0.52 |
| based AWG | Abu Dhabi | 8760 | 0-100% | 45 | 0.45 |
| (Prior art) | Riyadh | 8760 | 0-100% | 104 | 1.04 |

### Example 3

There will be times when the ambient air moisture content is lower than the moisture coming out from the reactivation air outlet stream. This is effectively a waste of moisture available for harvesting, albeit small. In this example, the reactivation air outlet flow, when higher in moisture than the ambient process air in flow, it is, through the control unit, automatically directed to process air in flow for creating higher process in moisture condition to the process sector of the adsorption wheel.

TABLE 3
Performance comparison with or without mixing

| | | | Moisture | | |
|---|---|---|---|---|---|
| | | | content at | | |
| | | Ambient | reactivation | | |
| | | moisture | air outlet | Moisture | |
| | | content; | after | content | |
| | | condition: | evaporator | at | Water |
| | Hours/year | 30° C., 30% | cum | process | generated |
| | (full year) | RH) | condenser | air inlet | litre/day |
| Present | 8760 | 55.3 gr/lb | 74.8 gr/lb | 55.3 gr/lb | 14.1 |
| invention | | | | | |
| but | | | | | |
| without | | | | | |
| mixing | | | | | |
| Present | 8760 | 55.3 gr/lb | 74.8 gr/lb | 61.8 gr/lb | 27.4 |
| invention | | | | | |
| with | | | | | |
| mixing | | | | | |

In the above Table 3, a typical react out air moisture content has been assumed as 74.8 gr/lb and correspondingly process in air condition before mixing must be equal to or less than 74.8 gr/lb. In this example, the ambient moisture content of 55.3 gr/lb (30° C. and 30% RH) has been assumed. Accordingly, the mixed air condition has been computed using a given mixing ratio of reactivation air out and process air in. This resultant process air in moisture content is higher at 61.8 gr/lb than the moisture in the ambient air at 55.3 gr/lb, thereby increasing the potential for water harvesting. This is an integral feature of the invention.

In all the above foregoing examples, where the evaporator load demands more heat rejection than available/possible through the main “heat” condenser [1110], the control unit automatically provides the integration of the auxiliary condenser [1118a, 1118bb] in the refrigeration system within alternate embodiments.

### LIST OF COMPONENTS

[1100]—Adsorption moisture pump based air to water harvesting device
[1102]—Desiccant wheel
[1104]—Heat pump unit
[1106]—Process sector
[1106a]—Process air inlet
[1106b]—Process air outlet
[1108]—Reactivation sector
[1108a]—Reactivation air inlet
[1108b]—Reactivation air outlet
[1110]—Main condenser
[1112]—Evaporator
[1114]—Compressor
[1116]—Expansion valve
[1118a, 1118b]—Auxiliary condenser

1. An adsorption moisture pump based air to water harvesting device, comprising:
a rotary desiccant unit, including:
a desiccant wheel including at least a process sector and a reactivation sector, and a wheel drive;
a reactivation air inlet and a reactivation air outlet, such that reactivation air is supplied from the reactivation air inlet to the reactivation air outlet through the reactivation sector;
a process air inlet and a process air outlet, such that process air is supplied from the process air inlet to the process air outlet through the process sector;
a heat pump unit, comprising: at least one compressor, an expansion valve; an evaporator, a main condenser, and such that a refrigerant fluid is flown sequentially within the compressor, the main condenser, the expansion valve, and the evaporator;
a control unit;
wherein:
the main condenser receives the reactivation air from the reactivation air inlet, before supplying the same to the reactivation sector,
the evaporator receives the reactivation air from the reactivation air outlet after the same exits the reactivation sector, causing condensation of water from the reactivation air passing therethrough;
the compressor is a capacity controlled compressor;
the reactivation air in the reactivation air outlet is mixed with process air in the process air inlet, whenever higher in moisture content than the outside ambient moisture content;
the control unit is adapted to receive one or more input parameters from the group consisting of an ambient temperature, an ambient humidity, a reactivation air inlet temperature, an operating mode; and control one or more of compressor capacity, reactivation air outlet process air inlet react-to-process air, react run-around, auxiliary condenser, evaporator temperature, based on the received input parameters.

2. The adsorption moisture pump based air to water harvesting device as claimed in claim 1, wherein the operation mode is configured to either maximize water extraction in terms of liters/day or reduce energy consumption in terms of liters/kW.

3. The adsorption moisture pump based air to water harvesting device as claimed in claim 1, wherein the heat pump unit comprises an auxiliary condenser, such that refrigerant fluid is flown sequentially to the main condenser, then the auxiliary condenser, expansion valve, the evaporator, and back to the compressor.

4. The adsorption moisture pump based air to water harvesting device as claimed in claim 3, wherein the auxiliary condenser is adapted to receive the reactivation air from the evaporator or an ambient air.

5. The adsorption moisture pump based air to water harvesting device as claimed in claim 1, wherein the main condenser of the heat pump unit facilitates heat transfer from the inflowing refrigerant fluid to the reactivation air flowing therethrough.

6. The adsorption moisture pump based air to water harvesting device as claimed in claim 1, wherein the evaporator of the heat pump unit facilitates heat transfer from the reactivation air flowing therethrough to the inflowing refrigerant fluid, to cause condensation of water from the reactivation air.

7. The adsorption moisture pump based air to water harvesting device as claimed in claim 1, comprising a storage unit for receiving the condensed water from the evaporator unit.

8. The adsorption moisture pump based air to water harvesting device as claimed in claim 3, wherein the auxiliary condenser of the heat pump unit facilitates heat transfer from the inflowing refrigerant fluid to either of the reactivation air and the ambient air flowing therethrough.

9. The adsorption moisture pump based air to water harvesting device as claimed in claim 1, wherein the compressor is a capacity controlled compressor wherein the compressor capacity is varied by varying either through speed or electronic control or hot gas bypass, based on the input parameters received by the control unit, in order to achieve a desired water extraction capacity or energy minimizing.

10. The adsorption moisture pump based air to water harvesting device as claimed in claim 1, wherein a portion of reactivation air from the reactivation air outlet is recirculated to the reactivation air inlet.

11. The adsorption moisture pump based air to water harvesting device as claimed in claim 1, wherein the water harvesting device is powered from a grid, one or more solar photovoltaic cells, or a combination thereof.

12. The adsorption moisture pump based air to water harvesting device as claimed in claim 1, wherein the desiccant wheel comprises an adsorbent matrix comprising one or more adsorbents is adhered to a substrate.

13. The adsorption moisture pump based air to water harvesting device as claimed in claim 1, wherein the one or more adsorbents are selected from the group consisting of metal organic frameworks (MOFs), covalent organic frameworks (COFs), zeolitic imidazolate frameworks (ZIFs), alone or in combination thereof, with or without an inorganic adsorbent.

14. The adsorption moisture pump based air to water harvesting device as claimed in claim 1, wherein the one or more adsorbents are selected from the group consisting of silica gel, zeolites, aluminas, reactive oxygen species (ROS), functionalized adsorbent, alone or in combination thereof.

15. The adsorption moisture pump based air to water harvesting device as claimed in claim 16, wherein the adsorbent matrix comprises one or more smaller passages disposed axially, such that the smaller passages are formed by alternating layers of flat and corrugated substrate material carrying the one or more adsorbents.

16. The adsorption moisture pump based air to water harvesting device as claimed in claim 12, wherein the adsorbent matrix is in the form of a honeycomb.

17. The adsorption moisture pump based air to water harvesting device as claimed in claim 1, wherein the water harvesting device comprises one or more fans adapted for generating a flow of the reactivation air and/or the process air.

18. The adsorption moisture pump based air to water harvesting device as claimed in claim 1, wherein a portion of the cooled reactivation out air is supplied to a closed space as conditioned air.

19. A method of harvesting water from ambient air, the method comprising:
installing a rotary desiccant unit having a desiccant wheel comprising at least a process sector and a reactivation sector [1108], such that the rotary desiccant unit defines, a reactivation air inlet and a reactivation air outlet [1108b] allowing the reactivation air to pass therethrough, and a process air inlet and a process air outlet allowing the process air to pass therethrough;
installing a heat pump unit functioning in relation with the rotary desiccant unit, such that the heat pump unit comprises: at least one compressor, an expansion valve; an evaporator, a main condenser, and a refrigerant fluid is flown sequentially within the compressor, the main condenser, the expansion valve, and the evaporator;
installing a control unit;
wherein:
the main condenser receives the reactivation air from the reactivation air inlet, before supplying the same to the reactivation sector;
the evaporator receives the reactivation air from the reactivation air outlet after the same exits the reactivation sector, causing condensation of water from the reactivation air passing therethrough;
the compressor is a capacity controlled compressor;
the reactivation air in the reactivation air outlet is mixed with process air in the process air inlet, whenever higher in moisture content than the outside ambient moisture content;
the control unit is adapted to receive one or more input parameters from the group consisting of an ambient temperature, an ambient humidity, a reactivation air inlet temperature, an operating mode; and control one or more of compressor capacity, react-to-process air, react run-around, auxiliary condenser, evaporator temperature, based on the received input parameters.

20. The method of harvesting water from ambient air as claimed in claim 19, wherein the operation mode is configured to either maximize water extraction in terms of liters/day or reduce energy consumption in terms of liters/kW.

21. The method of harvesting water from ambient air as claimed in claim 19, wherein the method comprises receiving the reactivation air from the evaporator or an ambient air in an auxiliary condenser of the heat pump unit to transfer heat from the refrigerant fluid to the inflowing reactivation air or ambient air.

22. The method of harvesting water from ambient air as claimed in claim 21, wherein the auxiliary condenser is placed such that refrigerant fluid is flown sequentially to the main condenser, then the auxiliary condenser, expansion valve, the evaporator, and back to the compressor.

23. The method of harvesting water from ambient air as claimed in claim 19, wherein the main condenser of the heat pump unit facilitates heat transfer from the inflowing refrigerant fluid to the reactivation air flowing therethrough.

24. The method of harvesting water from ambient air as claimed in claim 19 wherein the evaporator of the heat pump unit facilitates heat transfer from the reactivation air flowing therethrough to the inflowing refrigerant fluid, to cause condensation of water from the reactivation air.

25. The method of harvesting water from ambient air as claimed in claim 19, wherein the method comprises installing a storage unit for receiving the condenser water from the evaporator unit.

26. The method of harvesting water from ambient air as claimed in claim 21, wherein the auxiliary condenser of the heat pump unit facilitates heat transfer from the inflowing refrigerant fluid to either of the reactivation air and the ambient air flowing therethrough.

27. The method of harvesting water from ambient air as claimed in claim 19, wherein the compressor is a capacity controlled compressor wherein the compressor capacity is varied by varying either through speed or electronic control or hot gas bypass, based on the input parameters received by the control unit, in order to achieve a desired water extraction capacity or energy minimizing.

28. The method of harvesting water from ambient air as claimed in claim 19, wherein a portion of reactivation air from the reactivation air outlet is recirculated to the reactivation air inlet.

29. The method of harvesting water from ambient air as claimed in claim 19, wherein the method comprises powering the water harvesting device from a grid, one or more solar photovoltaic cells, or a combination thereof.

30. The method of harvesting water from ambient air as claimed in claim 19, wherein the desiccant wheel comprises an adsorbent matrix comprising one or more adsorbents adhered to a substrate.

31. The method of harvesting water from ambient air as claimed in claim 30, wherein the one or more adsorbents are selected from the group consisting of metal organic frameworks (MOFs), covalent organic frameworks (COFs), zeolitic imidazolate frameworks (ZIFs), alone or in combination thereof, with or without an inorganic adsorbent.

32. The method of harvesting water from ambient air as claimed in claim 30, wherein the one or more adsorbents are selected from the group consisting of silica gel, zeolites, aluminas, reactive oxygen species (ROS), functionalized adsorbent.

33. The method of harvesting water from ambient air as claimed in claim 30, wherein the adsorbent matrix comprises one or more smaller passages disposed axially, such that the smaller passages are formed by alternating layers of flat and corrugated substrate material carrying the one or more adsorbents.

34. The method of harvesting water from ambient air as claimed in claim 30, wherein the adsorbent matrix is in the form of a honeycomb.

35. The method of harvesting water from ambient air as claimed in claim 19, wherein the method comprises installing one or more fans adapted for generating a flow of one or more of the reactivation air, and/or the process air.

36. The method of harvesting water from ambient air as claimed in claim 19, wherein a portion of the cooled reactivation out air is supplied to a closed space as conditioned air.
